(19) United States
(12) Patent Application Publication
(10) Pub. No.: US 2026/0288247 A1
(43) Pub. Date: Sep. 24, 2026

(54) SYSTEMS AND METHODS FOR CONFIGURING INCIDENT DATA GENERATED USING A SPATIAL COMPUTING DEVICE

(71) Applicant: BANK OF AMERICA CORPORATION, Charlotte, NC (US)

(72) Inventor: Shailendra Singh, Thane West (IN)

(73) Assignee: BANK OF AMERICA CORPORATION, Charlotte, NC (US)

(21) Appl. No.: 19/087,766

(22) Filed: Mar. 24, 2025

(51) Int. Cl. G06F 3/01; H04L 41/22

(52) U.S. Cl. CPC G06F 3/017; H04L 41/22

(57) ABSTRACT

Systems, computer program products, and methods are described herein for configuring incident data generated using a spatial computing device. The present disclosure provides a solution that may configured to receive a triggering gesture from a user via a spatial computing device. The solution may isolate the triggering gesture and generate a report including the triggering gesture. The solution may configure the spatial computing device to receive report updates from the user. The solution may generate a communication interface including a destination, the triggering gesture, and the report updates. The solution may transmit the communication interface to an entity.

### TECHNOLOGICAL FIELD

Example embodiments of the present disclosure relate to configuring incident data generated using a spatial computing device.

### BACKGROUND

There are significant issues generating reports based on requirements set out by regulatory entities. Applicant has identified a number of deficiencies and problems associated with conventional procedures for generating and handling reports. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for configuring incident data generated using a spatial computing device.

Embodiments of the present invention address the above needs and/or achieve other advantages by providing apparatuses (e.g., a system, computer program product, and/or other devices) and methods for configuring incident data generated using a spatial computing device. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure provides a solution that is configured to receive a triggering gesture from a user via a spatial computing device. In some embodiments, the solution may isolate the triggering gesture using an artificial intelligence (AI) engine, wherein the AI engine uses a deep learning engine to differentiate the triggering gesture from other gestures and from a background scene captured by the spatial computing device. In some embodiments, the solution may generate a report including the triggering gesture, wherein the report is configured to include a destination, wherein the destination is associated with an entity responsible for handling the report. In some embodiments, the solution may configure the spatial computing device to receive report updates from the user. In some embodiments, the solution may generate a communication interface including the destination, the triggering gesture, and the report updates. In some embodiments, the solution may transmit the communication interface to the entity using the destination.

In some embodiments, the solution may receive a status update associated with the report from the entity. In some embodiments, the solution may generate an update interface wherein the update interface configures a graphical user interface associated with the spatial computing device. In some embodiments, the solution may transmit the update interface to the spatial computing device.

In some embodiments, the status update may include a plurality of status updates from the entity based on a resolution status of the report.

In some embodiments, the solution may receive an additional report update from the user, wherein the additional report update configures the report.

In some embodiments, the triggering gesture may include at least one of: at least one specific movement performed by the user, a specific speech pattern, or a specific visual cue.

In some embodiments, the report updates may include a report subject comprising an object captured by the spatial computing device, wherein the report subject is identified by the user performing an identifying gesture.

In some embodiments, the report subject may include a first report subject an a second report subject, wherein at least one of the first report subject or the second report subject is no longer in the spatial computing device's field of view.

In some embodiments, the report updates may include at least one of: a plurality of additional gestures performed by the user to described an issue, a plurality of speech patterns performed by the user to describe the issue, a user selection of a plurality of standard report updates, or a user selection of a plurality of AI report updates, wherein the plurality of AI report updates is generated by the AI engine based on an object captured by the spatial computing device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for configuring incident data generated using a spatial computing device, in accordance with an embodiment of the disclosure;

FIG. 2 illustrates an exemplary generative AI subsystem 200, in accordance with an embodiment of the invention;

FIG. 3 illustrates an exemplary system for a spatial computing device generating a report after receiving a triggering gesture, in accordance with an embodiment of the disclosure;

FIG. 4 illustrates a process flow for configuring incident data generated using a spatial computing device, in accordance with an embodiment of the disclosure; and

FIG. 5 illustrates exemplary technical components used during the generation of a report, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present disclosure relates to systems and methods for configuring incident data generated using a spatial computing device. Specifically, the system enables automated report generation based on user gestures, allowing individuals—including those with disabilities—to submit reports regarding the user's feedback. The system includes artificial intelligence and deep learning to interpret user gestures, classify report subjects, and route reports to appropriate departments for resolution.

Currently, there is no standardized or automated mechanism for users, particularly those with disabilities, to submit reports regarding issues they encounter with a company's services or products, such as ATMs, credit card or debit card transactions, customer service interactions, or the like. Existing reporting systems often require manual input through inaccessible interfaces, making it difficult for users with visual, motor, or other impairments to effectively communicate their concerns. Additionally, traditional reporting methods rely on predefined forms or verbal interactions, which can be inefficient, prone to misinterpretation, and difficult to process at scale.

What is more, the present disclosure provides a technical solution to a technical problem. As described herein, the technical problem includes the lack of intuitive, gesture-based systems for users with disabilities to submit reports. The technical solution presented herein allows for a user to use a spatial computing device to capture user gestures, an AI engine to interpret those gestures, and a distributed workflow to automatically classify, route, and track reports. In particular, the system is an improvement over existing solutions to conventional systems, (i) with fewer steps to achieve the solution, thus reducing the amount of computing resources, such as processing resources, storage resources, network resources, and/or the like, that are being used (e.g., using AI to classify reports rather than relying on human interpretation), (ii) providing a more accurate solution to problem, thus reducing the number of resources required to remedy any errors made due to a less accurate solution (e.g., inferring report details based on a user's gesture instead of requiring users to type descriptions), (iii) removing manual input and waste from the implementation of the solution, thus improving speed and efficiency of the process and conserving computing resources (e.g., routing reports to the correct team or department rather than relying on customer service), (iv) determining an optimal amount of resources that need to be used to implement the solution, thus reducing network traffic and load on existing computing resources (e.g., by submitting the minimal set of resources required for processing each report). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the incident report processing system as described herein is a solution to the problem of inefficient and inaccessible financial service reporting by integrating AI spatial computing capabilities. Further, the incident report processing system may be characterized as identifying a specific improvement in computer capabilities and/or network functionalities in response to the incident report processing system's integration to existing devices, software, applications, and/or the like. In this way, the incident report processing system improves the capability of a system to efficiently process reports received from users by optimizing data processing, report routing, status tracking, and the like. Further, the incident report processing system improves the functionality of networks in response to reducing the resources consumed by the system (e.g., network resources, computing resources, memory resources, and/or the like).

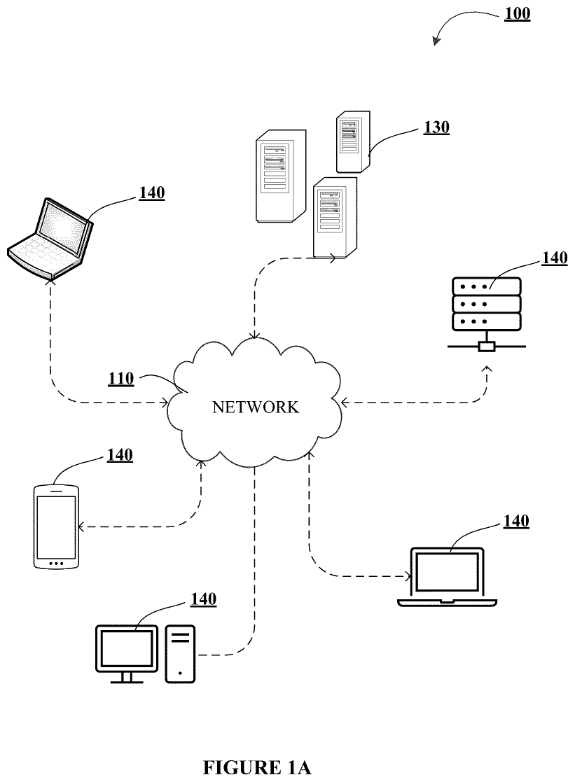

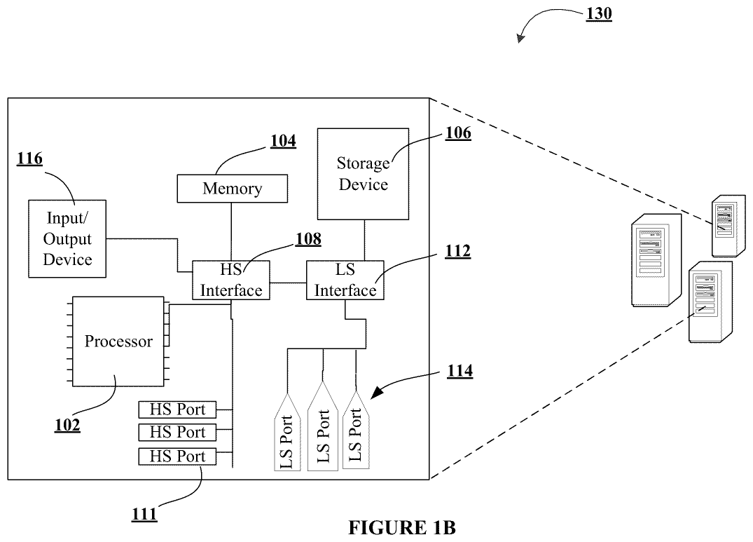

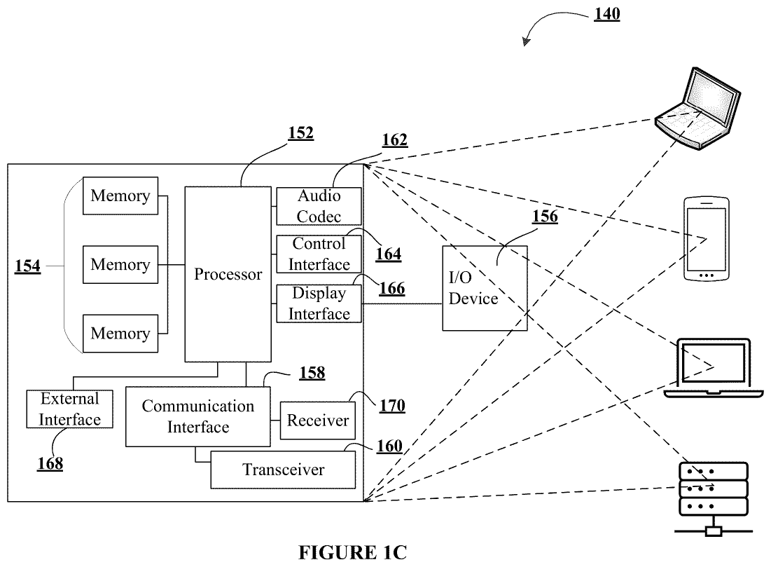

FIGS. 1A-1C illustrate technical components of an exemplary distributed computing environment 100 for configuring incident data generated using a spatial computing device, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

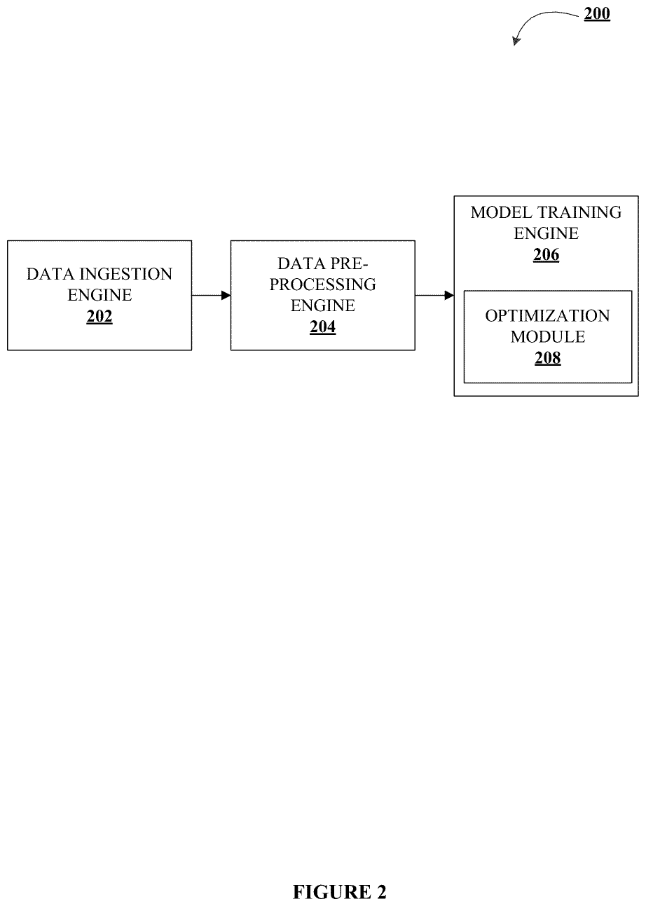

FIG. 2 illustrates an exemplary generative AI subsystem 200, in accordance with an embodiment of the invention. The generative AI subsystem 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

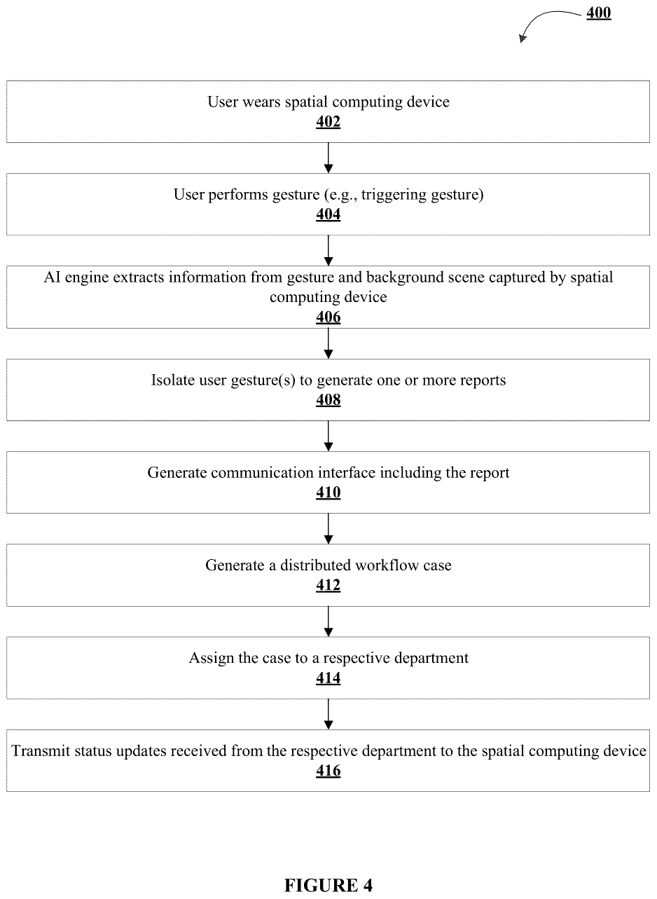

FIG. 4 illustrates a process flow for configuring incident data generated using a spatial computing device, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an incident report generation system (e.g., similar to one or more of the systems described herein with respect to FIGS. 1A-1C) may perform one or more of the steps of process flow 400. For example, an incident report generation system (e.g., the system 130 described herein with respect to FIGS. 1A-1C) may perform the steps of process flow 400.

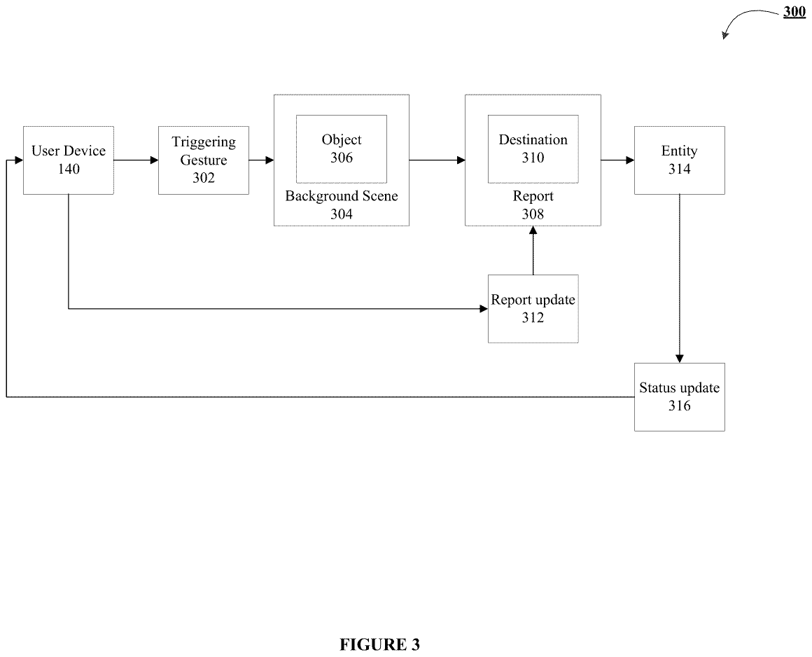

As shown in block 402, the process flow 400 of this embodiment includes a user wearing a spatial computing device. In some embodiments, the incident report generation system may receive a triggering gesture from the user via the spatial computing device. In some embodiments, the user device 140, as described in FIGS. 1A-1C, may include the spatial computing device. For example, as shown in FIG. 3, the user device 140 may include a spatial computing device 140. In some embodiments, the user device 140 may be a device other than a spatial computing device, but still may perform the functions as described herein. For instance, the user device 140 may include any other device as shown in FIGS. 1A-1C while still performing the functions as described herein with respect to a spatial computing device. Thus, it is to be understood the solutions as described herein are not to be limited to spatial computing device applications.

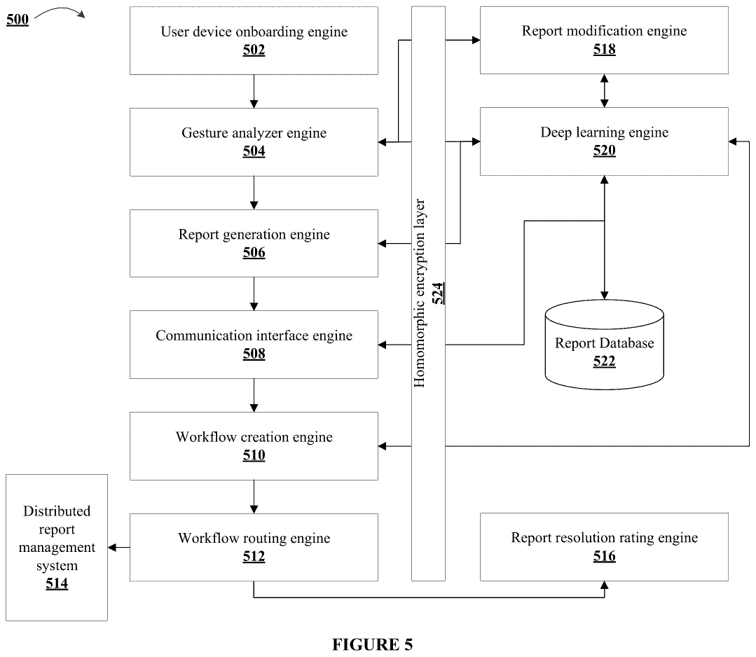

In some embodiments, and as shown in FIG. 5, the user device and/or spatial computing device 140 may be onboarded using a user device onboarding engine 502. In this regard, the user device onboarding engine 502 may be responsible may be responsible for integrating, configuring, authenticating, and the like the user's spatial computing device 140. For example, the user device onboarding engine 502 may ensure the spatial computing device 140 is properly set up to interact with the system's gesture-based, voice-based, or AI-based interfaces. It should be understood that an “engine” as described herein may include processes and functionalities that may performed by a processor. For example, a “user device onboarding engine” as shown in FIG. 5 may be performed by a processor (e.g., processor 102, processor 152, or the like) as described herein. In this way, and in some embodiments, the engines used to describe particular functions may be processes performed in a processor. Further, in some embodiments, the engines may include dedicated hardware and/or software to perform a particular function.

As shown in block 404, the process flow 400 of this embodiment includes the user performing a gesture, which may include a triggering gesture. In some embodiments, the triggering gesture may include at least one of: at least one specific movement performed by the user, a specific speech pattern, or a specific visual cue. For example, as shown in FIG. 3, the user may perform a triggering gesture 302, wherein the triggering gesture 302 is in the spatial computing device's 140 field of view. For example, the user may perform a predefined motion, such as pointing at an object, waving a hand, making a tapping motion, or the like. As shown in FIG. 5, a gesture analyzer engine 504 may process and interpret user gestures captured by the spatial computing device. In some embodiments, the gesture analyzer engine 504 may use computer vision, machine learning, motion tracking, or the like to differentiate between intentional gestures and background movements. In some embodiments, the gesture analyzer engine 504 may use gesture patterns, velocity, spatial positioning, or the like to trigger specific system actions, such as submitting a report, selecting menu options, confirming issues, and the like.

In some embodiments, the gesture analyzer engine 504 may communicate with a deep learning engine 520. In some embodiments, and as shown in FIG. 5, a homomorphic encryption layer 524 may be between the gesture analyzer engine 504 and deep learning engine 520. In this regard, the encryption layer 524 may enable secure data processing while keeping sensitive data fully encrypted. The deep learning engine 520 may allow further computations on the data from the gesture analyzer engine 504. In some embodiments, the results may be sent back to the gesture analyzer engine 504. In some embodiments, the deep learning engine 520 may communicate with the report database 522 that stores and manages user-generated report, logs, resolution statuses, and the like. In some embodiments, the deep learning engine 520 may use the report database 522 to analyze historical reports, improve classifications and predictions, optimize workflow routings, and the like.

In some embodiments, the user may set a specific movement or series of movements that may be interpreted by the system as the triggering gesture. For instance, the user may set a combination of movements, such as a wave and a point, that are the triggering gesture. Further, the system may differentiate between non-triggering gesture movements and triggering gesture movements. For example, the system may understand the difference between a casual hand movement and an intentional gesture performed by the user by using a combination of motion tracking and AI-based gesture recognition techniques.

Further, in some embodiments, the system may recognize specific verbal commands or speech patterns (e.g., the user saying “report issue,” “help,” “malfunction,” “generate report,” or the like) to as a triggering gesture which initiates the process as described herein. In some embodiments, natural language processing (NLP) algorithms may filter background noise and confirm the intent of the user prior to triggering a report generation. Additionally, or alternatively, in some embodiments, visual cues may be used by the user as a triggering gesture, which may include the user placing a specific object in the spatial computing device's line of sight. For example, a specific card may be used by the user to signal to the system that the user would like to generate a report (e.g., the specific card may be used as the triggering gesture). Further, in some embodiments, the user may use a combination of triggering gestures to initiate the process.

As shown in block 406, the process flow 400 of this embodiment includes an AI engine extracting information from the gesture and background scene captured by the spatial computing device. For example, as shown in FIG. 3, the spatial computing device 140 may capture, ingest, record, or otherwise view a background scene 304 and an object 306. In some embodiments, the system may analyze, using the gesture analyzer engine 504, the user's triggering gesture by comparing it against a trained deep learning model that has been trained with various other triggering gestures (e.g., hand motions, postures, movement patterns, speech patterns, objects, etc.). In some embodiments, the AI engine may use skeletal tracking, motion detection, trajectory analysis, or the like to confirm that the gesture performed by the user matches the predefined triggering gesture. In some embodiments, if multiple gestures are detected or occur simultaneously, the system may be able to filter out irrelevant movements. For example, if the spatial device is capturing another person making a gesture, the system may ignore that other person's gesture if it occurs at the same time as the user's triggering gesture.

In some embodiments, the system may scan (using the gesture analyzer engine 504) the background scene (e.g., background scene 304) to detect objects (e.g., objects 306) that may be relevant to the report, such as an ATM, debit card reader, debit or credit card, or the like. In this regard, the system may use object recognition and scene segmentation to distinguish between different elements in the environment. Further, in some embodiments, if the user is pointing at a damaged ATM keypad, for example, the AI engine may recognize the ATM as the object 306 and associate it with a report.

Further, in some embodiments, the system may enrich the data captured by the spatial computing device with contextual data. For example, if a damaged ATM is the object 306 for which a report is generated, the system, via the AI engine, may also capture the ATM's device ID, location data, a time stamp, pictures and/or videos, and the like. The additional contextual data may enrich the report by adding information specific to the object 306.

In some embodiments, the system may filter out environmental noise. In situations where the spatial computing device captures excess noise, data, or distractions, the system may recognize the unnecessary noise and eliminate it from the report. For example, a screen on an ATM (e.g., the object 306) may have a reflection, which may be determined by the AI engine to be environmental noise that can be ignored in the report.

As shown in block 408, the process flow 400 of this embodiment includes isolating the user gesture(s) to generate one or more reports. In this regard, the system may analyze the motion patterns, trajectory, context, and the like of the user's gesture. In some embodiments, the AI engine may determine whether the detected gesture corresponds to a triggering gesture for initiating a report. In some embodiments, and as shown in FIG. 5, a report generation engine 506 may automate the creation, structuring, formatting, and the like of reports based on user interactions captured by the spatial computing device 140. In some embodiments, the report generation engine 506 may collect inputs, speech patterns, contextual data, and the like to generate a report detailing the identified issue, relevant objects, and other data.

In some embodiments, the incident report generation system may isolate the triggering gesture using an AI engine, wherein the AI engine uses a deep learning engine to differentiate the triggering gesture from other gestures and from a background scene captured by the spatial computing device. For example, the system may differentiate between intentional gestures, background motions, and unrelated user movements captured by the spatial computing device. In some embodiments, the AI engine may use motion tracking and gesture differentiation techniques. In this regard, the system may use algorithms to analyze the user's posture, movements, gesture, and the like. The user's gestures and movements may be compared with gesture datasets that may match with a triggering gesture or a report update (e.g., pointing, tapping, waving, speaking, visual cues, etc.). In some embodiments, the system may be able to differentiate between multiple users in the field of view of the spatial computing device and may isolate the gesture belonging to the primary user interacting with the system. In some embodiments, the system may perform scene analysis and contextual filter to evaluate the background scene (e.g., background scene 304).

In some embodiments, the incident report generation system may generate a report including the triggering gesture, wherein the report is configured to include a destination, wherein the destination is associated with an entity responsible for handling the report. For example, as shown in FIG. 3, the report 308 may include the destination 310, wherein the destination 310 provides information, such as an address, to which the report is sent. In some embodiments, the entity may be a company or business to which the report is directed. Further, in some embodiments, the destination may include the entity and a specific department, team, individual, or the like associated with the entity to which the report is directed.

In some embodiments, the system may configure the spatial computing device to receive report updates from the user. In some embodiments, the report updates may include user provided details, clarifying information, modifications, or the like. In some embodiments, the system may prompt the user with follow up questions asking the user to confirm the accuracy of the report, add additional context, add supplementary data, or the like. Further, the spatial computing device may be dynamically configured to accept the report updates without the user restarting the reporting process, which may include additional gestures, speech inputs, interactions, or the like.

In some embodiments, the report updates may include a report subject including an object captured by the spatial computing device, wherein the report subject is identified by the user performing an identifying gesture. In some embodiments, the report subject may be the primary element or object (e.g., the object 306) associated with the report. In this regard, the user may be creating the report based upon the report subject. For example, the report subject may include a product associated with the entity, a service provided by the entity, an employee associated with the entity, or other function provided by the entity. In a specific non-limiting example, the report subject may include an ATM, a card reader, a credit card or debit card, a kiosk, an employee, a transaction pathway for opening a new account, an application interface, or the like.

In some embodiments, the user may identify the report subject by performing a gesture that indicates the user wishes to create a report about the report subject. For example, the gesture may include the user pointing to an ATM that the user wishes to create the report about. In some embodiments, the triggering gesture may be used to identify the report subject, and the spatial computing device may understand that the report should be created about the report subject upon receive a triggering gesture. In some embodiments, the user may perform an identifying gesture, separate from the triggering gesture, to identify the report subject. For example, an identifying gesture may include pointing towards the report subject, tapping on the report subject, circling the report subject, telling the spatial computing device what the report subject is, placing a visual cue in the spatial computing device's field of view that indicates the report subject (e.g., an arrow on a placard), or the like.

In some embodiments, once the identifying gesture is captured and processed, the AI engine may update the report subject to ensure the entity receives the most relevant information. In this regard, the gesture-based refinement process may allow for greater accuracy, reduced ambiguity, and improved efficiency in handling reports. Further, the accuracy and efficiency of the reporting process will be enhanced.

In some embodiments, the report updates may provide users with multiple ways to refine, expand, and/or clarify their initial report submission. For example, the user may add further context via gestures, speech patterns, predefined selections, or AI-generated recommendations. In some embodiments, the report updates may include a plurality of additional gestures performed by the user to describe an issue. In some embodiments, the user may point at multiple areas of the report subject, tap, perform other hand motions, or the like to convey additional information to the system. In this regard, the user may use non-verbal commands to convey information to the system in the report.

In some embodiments the report updates may include a plurality of speech patterns performed by the user to describe the issue. In some embodiments, the user may describe the issue verbally. For example, the user may provide descriptive explanations, and the spatial computing device may capture the speech patterns from the user, associate it with the identified object, and update the report accordingly. In some embodiments, the system may comprehend tones and the like the user may use to convey information, as well as provide multilingual support.

In some embodiments, the report updates may include a user selection of a plurality of standard report updates. In some embodiments, the user may select from a list of predefined standard report updates that provide relevant details without the user having to generate explanations. For example, a list may provide standard report updates such as “the ATM screen is frozen,” “the card reader is jammed,” “no resources received,” or the like. In some embodiments, the user may select from these options via the spatial computing device through a screen interface, a gesture interface, verbal commands, or the like.

In some embodiments, the report updates may include a user selection of a plurality of AI report updates, wherein the plurality of AI report updates is generated by the AI engine based on an object captured by the spatial computing device. In some embodiments, the system may provide the user a list of AI report updates that are specific to the user and the issue the user is having. For example, the system may use the AI engine to generate the report updates based on the object 306, the background scene 304, and other information ingested by the spatial computing device 140. In this regard, the spatial computing device 140 may use object recognition to automatically detect and suggest possible issues. Further, the AI engine may provide environmental context, user behavior analysis, and the like. In this way, the AI report updates may reduce manual inputs to the system by the user for generating reports.

In some embodiments, the report subject may include a first report subject and a second report subject, wherein at least one of the first report subject or the second report subject is no longer in the spatial computing device's field of view. In some embodiments, the user may need to report issues involving multiple objects. In this regard, the user may encounter two related but separate issues. For example, the user may encounter a malfunctioning ATM screen (e.g., the first report subject) and a broken receipt printer (e.g., the second report subject). In some embodiments, the spatial computing device may retain previously identified report subjects in its memory even if the user shifts the focus of the report subjects out of the field of view of the spatial computing device. For example, if the user initially identifies the ATM screen and the shifts focus to the receipt printer, the spatial computing device may retain the ATM screen as the first report subject. In this way, the user may make reports for both report subjects as the system may store both objects, even if one is no longer visible.

Further, in some embodiments, the system may use AI object tracking to maintain awareness of report subjects that exit the field of view of the spatial computing device. In this regard, the system may use spatial memory mapping to log the last known position of an object prior to it leaving the field of view. The system may later retrieve the stored information relating to that object, if needed. Further, in some embodiments, the system may use motion prediction algorithms if objects are expected to reappear as well as gesture and speech based recall techniques wherein the user may request the system recall previously identified objects or report subjects.

As shown in block 410, the process flow 400 of this embodiment includes generating a communication interface including the report. In some embodiments, the communication interface may serve as a structured digital package that facilitates the transmission of the incident report to the appropriate entity responsible for handling the report. In some embodiments, the communication interface may include report metadata, user input, system insights, entity details, and the like. As shown in FIG. 5, a communication interface engine 508 may include facilitating a data exchange and interaction between the spatial computing device and the system. In some embodiments, the communication interface engine 508 may ensure reports, status updates, user inputs, etc. are formatted and transmitted using various communication channels. For example, the communication interface engine 508 may use real-time bidirectional communication that allows users to receive report updates, respond to requests, or escalate unresolved reports.

In some embodiments, the communication interface may include a webhook used to communicate with the entity. In some embodiments, the webhook may include transmitting real-time report data to an external system, such as an entity's service portal, maintenance system, or the like. In some embodiments, the communication interface (e.g., webhook) may be triggered immediately when the report is finalized. In this regard, the webhook may send data to a predefined endpoint belonging to the responsible entity. In some embodiments, the recipient system may process the report automatically and update internal case management systems. In some embodiments, the entity may require more information from the user and may transmit a request for the user to update the report with more information and prompt the user for additional details.

In some embodiments, the system may generate a communication interface including the destination, the triggering gesture, and the report updates. In some embodiments, the communication interface may identify where the report should be sent which may include the relevant entity, the specific department, third parties, individuals, or the like. In some embodiments, the triggering gesture may be included that the user used to initiate the report. In this regard, the triggering gesture may indicate how and why the issue was flagged. Further, in some embodiments, the communication interface may include report updates which may include additional details provided by the user after the initial report submission.

As shown in block 412, the process flow 400 of this embodiment includes generating a distributed workflow case. In some embodiments, the distributed workflow case may include managing the end-to-end lifecycle of a report generated by a user. In this regard, the distributed workflow may accurately track, assign, and resolve reports by dynamically routing them to the appropriate personnel, departments, entities, or the like. As shown in FIG. 5, a workflow creation engine 510 may automate the process of handling the generation of workflows based on report data, assigning tasks to the appropriate departments, prioritizing issues, and setting escalation rules. In some embodiments, the workflow creation engine 510 may use AI engine decision making that optimizes workflows. Further, in some embodiments, a workflow routing engine 512 may direct reports to the appropriate departments or entities. In some embodiments, the AI engine may use predefined rules and real-time conditions to route the reports. For example, the workflow routing engine 512 may use report type, prioritizations, workload distributions, resolution history, and the like, to optimize report assignments.

Further, in some embodiments, the distributed workflow may use a secure blockchain based distributed report recording and tracking system. For example, as shown in FIG. 5, a distributed report management system 514 may be used. In some embodiments, the secure blockchain based distributed report recording and tracking system may be specific to certain industries or institutions, such as a financial institution. For example, the distributed report management system 514 may use blockchain to ensure real-time access of stakeholders to allow for report resolution. In this regard, the secure blockchain system may ensure the reports are immutable, transparent, decentralized, and secure. In some embodiments, smart contracts may be used to allow predefined conditions to trigger specific actions (e.g., automatic escalation of certain reports, real-time report updates, and the like).

As shown in block 414, the process flow 400 of this embodiment includes assigning the case to a respective department. In some embodiments, assigning the case (e.g., the report) to a respective department may include the department reviewing, resolving, or taking further action on the report. In some embodiments, the assignment process may be powered by the AI engine which may use real-time data analysis and intelligent workflow automations. In some embodiments, the reports may be prioritized based on the nature of the issue in the report, the urgency level, the responsible department, and the like. For example, if equipment malfunctions or errors are the basis of the report, a maintenance team may be the department to which the report is assigned.

In some embodiments, the system may transmit the communication interface to the entity using the destination. In some embodiments, the system may use the AI engine to analyze the report to determine which entity, department, or the like the communication interface should be transmitted to. For example, the AI engine may use natural language processing and pattern recognition to analyze the report to determine the appropriate destination used for transmitting the communication interface.

In some embodiments, the report may be associated with one or more appropriate entities, departments, individuals, or the like. For example, a report may be associated with a malfunctioning ATM and an authorized transaction. In this example, the system may generate one or more reports with the same or varying information that may be specific to the appropriate department and route the report(s) to the departments. Further, in some embodiments, the system may create a shared report wherein multiple departments may collaborate on the report resolution.

As shown in block 416, the process flow 400 of this embodiment includes transmitting status updates received from the respective department to the spatial computing device. In this way, the system may include a bi-directional communication loop wherein the spatial computing device can both receive updates but provide updates to the system, as well. Further, in some embodiments, the spatial computing device may provide users with options for additional actions (e.g., adding new details, confirming resolutions, escalating unresolved issues, etc.).

In some embodiments, the system may receive a status update associated with the report from the entity. Once a report is assigned to a department, entity, or the like, the system may continuously monitor the resolution process. In some embodiments, the system may receive a status update from the assigned entity handling the report, which may update the user throughout the issue resolution timeframe. For example, the types of status updates may include an acknowledgement, a progression update, additional information request, an escalation notification, a resolution confirmation, or the like.

In some embodiments, the status update may include a plurality of status updates from the entity based on a resolution status of the report. In some embodiments, the series of status updates may reflect different stages of report resolution. For example, multi-step resolution tracking may include report received notifications, departmental assignments, diagnosis and verifications, resolution actions, final confirmations, etc.

In some embodiments, the system may generate an update interface wherein the update interface configures a graphical user interface associated with the spatial computing device. In some embodiments, the system may transmit the update interface to the spatial computing device. In some embodiments, the update interface may include a visual progress tracker, real-time notifications, user action options, multimodal interactions, and the like. In this way, the user may provide an input, if needed, back to the system via the spatial computing device.

In some embodiments, the system may receive an additional report update from the user, wherein the additional report update configures the report. For example, as shown in FIG. 5, a report modification engine 518 may be used when the user submits additional report updates. In some embodiments, the additional report updates may include modifications, clarifications, or supplemental information to the initial report. For example, if an issue has changed, the user may update the report with an additional report update. In some embodiments, the user may submit additional updates with gesture-based interactions, voice commands, interface selections, or the like. In this regard, the report modification engine 518 may capture these additional report updates and configure the report to include them.

Further, in some embodiments, a report resolution rating engine 516 may be used for the user to submit feedback that evaluates the effectiveness of the report submission process. In this regard, the engine 516 may prompt the user to provide feedback through ratings, comments, gesture-based feedback, or the like that indicate the user's satisfaction with the handling of the report.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for configuring incident data generated using a spatial computing device, the system comprising:
a processing device;
a non-transitory storage device containing instructions when executed by the processing device, causes the processing device to perform the steps of:
receive a triggering gesture from a user via a spatial computing device;
isolate the triggering gesture using an artificial intelligence (AI) engine, wherein the AI engine uses a deep learning engine to differentiate the triggering gesture from other gestures and from a background scene captured by the spatial computing device;
generate a report comprising the triggering gesture, wherein the report is configured to include a destination, wherein the destination is associated with an entity responsible for handling the report;
configure the spatial computing device to receive report updates from the user;
generate a communication interface comprising the destination, the triggering gesture, and the report updates; and
transmit the communication interface to the entity using the destination.

2. The system of claim 1, wherein executing the instructions further causes the processing device to:
receive a status update associated with the report from the entity;
generate an update interface wherein the update interface configures a graphical user interface associated with the spatial computing device; and
transmit the update interface to the spatial computing device.

3. The system of claim 2, wherein the status update comprises a plurality of status updates from the entity based on a resolution status of the report.

4. The system of claim 2, wherein executing the instructions further causes the processing device to receive an additional report update from the user, wherein the additional report update configures the report.

5. The system of claim 1, wherein the triggering gesture comprises at least one of:
at least one specific movement performed by the user;
a specific speech pattern; or
a specific visual cue.

6. The system of claim 1, wherein the report updates comprise a report subject comprising an object captured by the spatial computing device, and wherein the report subject is identified by the user performing an identifying gesture.

7. The system of claim 6, wherein the report subject comprises a first report subject and a second report subject, and wherein at least one of the first report subject or the second report subject is no longer in the spatial computing device's field of view.

8. The system of claim 1, wherein the report updates comprise at least one of:
a plurality of additional gestures performed by the user to describe an issue;
a plurality of speech patterns performed by the user to describe the issue;
a user selection of a plurality of standard report updates; or
a user selection of a plurality of AI report updates, wherein the plurality of AI report updates is generated by the AI engine based on an object captured by the spatial computing device.

9. A computer program product for configuring data generated using a spatial computing device, the computer program product comprising a non-transitory computer-readable medium comprising code causing an apparatus to:
receive a triggering gesture from a user via a spatial computing device;
isolate the triggering gesture using an artificial intelligence (AI) engine, wherein the AI engine uses a deep learning engine to differentiate the triggering gesture from other gestures and from a background scene captured by the spatial computing device;
generate a report comprising the triggering gesture, wherein the report is configured to include a destination, wherein the destination is associated with an entity responsible for handling the report;
configure the spatial computing device to receive report updates from the user;
generate a communication interface comprising the destination, the triggering gesture, and the report updates; and
transmit the communication interface to the entity using the destination.

10. The computer program product of claim 9, wherein the code further causes the apparatus to:
receive a status update associated with the report from the entity;
generate an update interface wherein the update interface configures a graphical user interface associated with the spatial computing device; and
transmit the update interface to the spatial computing device.

11. The computer program product of claim 10, wherein the status update comprises a plurality of status updates from the entity based on a resolution status of the report.

12. The computer program product of claim 10, the computer program product comprising a non-transitory computer-readable medium comprising code causing an apparatus to receive an additional report update from the user, wherein the additional report update configures the report.

13. The computer program product of claim 9, wherein the triggering gesture comprises at least one of:
at least one specific movement performed by the user;
a specific speech pattern; or
a specific visual cue.

14. The computer program product of claim 9, wherein the report updates comprise a report subject comprising an object captured by the spatial computing device, and wherein the report subject is identified by the user performing an identifying gesture.

15. The computer program product of claim 14, wherein the report subject comprises a first report subject and a second report subject, and wherein at least one of the first report subject or the second report subject is no longer in the spatial computing device's field of view.

16. The computer program product of claim 9, wherein the report updates comprise at least one of:
a plurality of additional gestures performed by the user to describe an issue;
a plurality of speech patterns performed by the user to describe the issue;
a user selection of a plurality of standard report updates; or
a user selection of a plurality of AI report updates, wherein the plurality of AI report updates is generated by the AI engine based on an object captured by the spatial computing device.

17. A method for configuring incident data generated using a spatial computing device, the method comprising:
receiving a triggering gesture from a user via a spatial computing device;
isolating the triggering gesture using an artificial intelligence (AI) engine, wherein the AI engine uses a deep learning engine to differentiate the triggering gesture from other gestures and from a background scene captured by the spatial computing device;
generating a report comprising the triggering gesture, wherein the report is configured to include a destination, wherein the destination is associated with an entity responsible for handling the report;
configuring the spatial computing device to receive report updates from the user;
generating a communication interface comprising the destination, the triggering gesture, and the report updates; and
transmitting the communication interface to the entity using the destination.

18. The method of claim 17, wherein the method further comprises:
receiving a status update associated with the report from the entity;
generating an update interface wherein the update interface configures a graphical user interface associated with the spatial computing device; and
transmitting the update interface to the spatial computing device.

19. The method of claim 18, wherein the status update comprises a plurality of status updates from the entity based on a resolution status of the report.

20. The method of claim 18, wherein the method further comprises receiving an additional report update from the user, wherein the additional report update configures the report.
